(19) United States
(12) Patent Application Publication
(10) Pub. No.: US 2021/0342722 A1
(43) Pub. Date: Nov. 4, 2021

(54) AIR QUALITY PREDICTION MODEL TRAINING METHOD, AIR QUALITY PREDICTION METHOD, ELECTRONIC DEVICE AND STORAGE MEDIUM

(71) Applicant: Beijing Baidu Netcom Science and Technology Co., Ltd., Beijing (CN)

(72) Inventors: Jindong Han, Beijing (CN); Hao Liu, Beijing (CN)

(21) Appl. No.: 17/376,256

(22) Filed: Jul. 15, 2021

(30) Foreign Application Priority Data
Dec. 23, 2020 (CN) 202011548395.0

(51) Int. Cl. G06N 5/04; G06N 20/00

(52) U.S. Cl. CPC G06N 5/04; G06N 20/00

(57) ABSTRACT

An air quality prediction model training method, an air quality prediction method, an electronic device and a storage medium are provided, and relate to the technical field of artificial intelligence, such as deep learning and big data. The training method includes: establishing an air quality prediction model according to spatial correlation information among a plurality of regions; and adjusting the air quality prediction model according to air quality observation values for the plurality of regions and air quality prediction values for the plurality of regions output by the air quality prediction model. The accuracy of air quality prediction result can be improved.

### CROSS-REFERENCE TO RELATED APPLICATION

This application claims priority to Chinese Patent Application No. 202011548395.0, filed on Dec. 23, 2020, which is hereby incorporated by reference in its entirety.

### TECHNICAL FIELD

The present disclosure relates to the technical field of computer technology, and in particular to the technical field of artificial intelligence, such as deep learning and big data.

### BACKGROUND

With the development of economy and technology and the improvement of people's living conditions, people are paying more and more attention to life and health, and they also have higher and higher quality and safety requirements for the living environment.

Due to the rapid increase in the level of industrialization, air quality has become one of the factors closely related to people's life and health issues, and the demand for air quality prediction is also gradually increasing in fields such as weather forecasting and tourism. It is one of the primary needs of people for air quality prediction and weather forecasting that prediction data can be sufficiently accurate.

### SUMMARY

The present disclosure provides an air quality prediction model training method, an air quality prediction method, an apparatus, a device and a storage medium.

According to an aspect of the present disclosure, there is provided an air quality prediction model training method, and the method includes:

establishing an air quality prediction model according to spatial correlation information among a plurality of regions; and

adjusting the air quality prediction model according to air quality observation values for the plurality of regions and air quality prediction values for the plurality of regions output by the air quality prediction model.

According to another aspect of the present disclosure, there is provided an air quality prediction method, and the method includes:

inputting spatial correlation information among a plurality of regions serving as input data into an air quality prediction model to obtain air quality prediction values, the air quality prediction model being the air quality prediction model provided by any one of embodiments of the present disclosure.

According to yet another aspect of the present disclosure, there is provided an air quality prediction model training apparatus, and the apparatus includes:

an establishing module, configured for establishing an air quality prediction model according to spatial correlation information among a plurality of regions; and

an adjusting module, configured for adjusting the air quality prediction model according to air quality observation values for the plurality of regions and air quality prediction values for the plurality of regions output by the air quality prediction model.

According to still another aspect of the present disclosure, there is provided an air quality prediction apparatus, and the apparatus includes:

a prediction module, configured for inputting spatial correlation information among a plurality of regions serving as input data into an air quality prediction model to obtain air quality prediction values, the air quality prediction model being the air quality prediction model provided by any one of embodiments of the present disclosure.

According to another aspect of the present disclosure, there is provided an electronic device, and the electronic device includes:

at least one processor; and

a memory communicatively connected to the at least one processor; wherein,

the memory is stored with instructions executable by the at least one processor to enable the at least one processor to perform the method provided by any one of embodiments of the present disclosure.

According to yet another aspect of the present disclosure, there is provided a non-transitory computer-readable storage medium storing computer instructions for causing the computer to perform the method provided by any one of embodiments of the present disclosure.

According to still another aspect of the present disclosure, there is provided a computer program product, and the computer program product includes a computer program which, when executed by a processor, implements the method provided by any one of embodiments of the present disclosure.

It is to be understood that the contents in this section are not intended to identify the key or critical features of the embodiments of the present disclosure, and are not intended to limit the scope of the present disclosure. Other features of the present disclosure will become readily apparent from the following description.

### BRIEF DESCRIPTION OF THE DRAWINGS

The drawings are included to provide a better understanding of the present disclosure and are not to be construed as limiting the present disclosure. Wherein:

FIG. 1 is a schematic flowchart of an air quality prediction model training method according to a first embodiment of the present disclosure;

FIG. 2 is a schematic diagram of region division and parameter calculation according to an example of the present disclosure;

FIG. 3 is a schematic flowchart of an air quality prediction method according to an embodiment of the present disclosure;

FIG. 4 is a schematic flowchart of an air quality prediction model training method according to an example of the present disclosure;

FIG. 5 is a schematic diagram of an air quality prediction apparatus according to an embodiment of the present disclosure;

FIG. 6 is a schematic diagram of an air quality prediction apparatus according to another embodiment of the present disclosure;

FIG. 7 is a schematic diagram of an air quality prediction apparatus according to yet another embodiment of the present disclosure;

FIG. 8 is a schematic diagram of an air quality prediction apparatus according to yet another embodiment of the present disclosure;

FIG. 9 is a schematic diagram of an air quality prediction apparatus according to yet another embodiment of the present disclosure;

FIG. 10 is a schematic diagram of an air quality prediction apparatus according to yet another embodiment of the present disclosure;

FIG. 11 is a schematic diagram of an air quality prediction apparatus according to yet another embodiment of the present disclosure;

FIG. 12 is a schematic diagram of an air quality prediction apparatus according to yet another embodiment of the present disclosure; and

FIG. 13 is a block diagram of an electronic device configured for implementing a method provided by embodiments of the present disclosure.

### DETAILED DESCRIPTION

Exemplary embodiments of the present disclosure are described below with reference to the accompanying drawings, wherein the various details of the embodiments of the present disclosure are included to facilitate understanding and are to be considered as exemplary only. Accordingly, a person skilled in the art should appreciate that various changes and modifications can be made to the embodiments described herein without departing from the scope and spirit of the present disclosure. Also, descriptions of well-known functions and structures are omitted from the following description for clarity and conciseness.

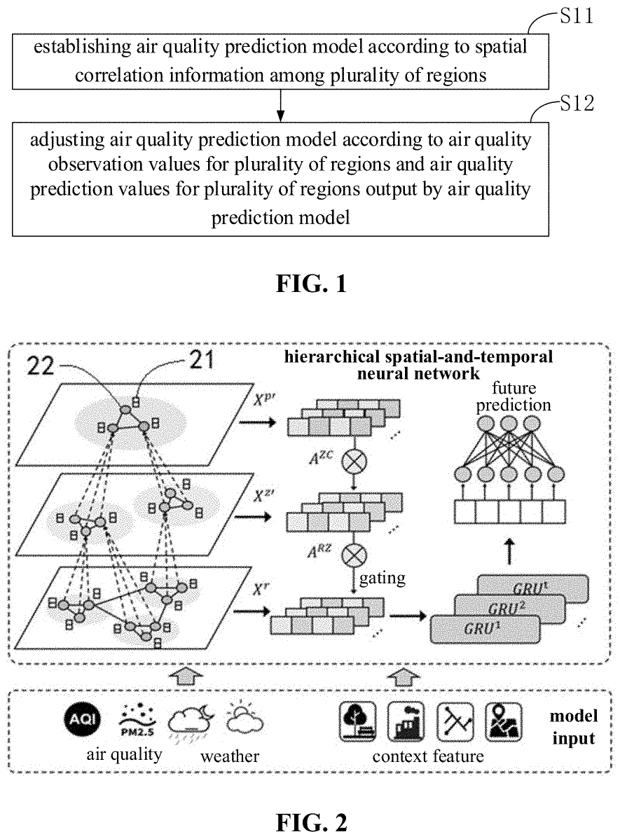

The embodiments of the present disclosure first provide an air quality prediction model training method. As shown in FIG. 1, the air quality prediction model training method includes:

S11. establishing an air quality prediction model according to spatial correlation information among a plurality of regions; and

S12. adjusting the air quality prediction model according to air quality observation values for the plurality of regions and air quality prediction values for the plurality of regions output by the air quality prediction model.

In the embodiments of the present disclosure, the plurality of regions can include a smaller range of regions obtained by dividing a certain target range, such as regions, counties, and townships formed by administrative divisions. The plurality of regions can also include a larger range of regions obtained by dividing a certain target range, such as cities, provinces, and autonomous regions.

The plurality of regions can belong to the same level of regions, or they can belong to different levels of regions. Regions of the same level are regions that do not overlap with each other, for example, all administrative regions belong to the same level, all cities belong to the same level, and so on.

Regions of the same level can also be regions with the same division method. For example, a plurality of regions divided according to environmental feature belong to the same level of regions, and a plurality of regions divided according to the functions of the regions belong to the same levels of regions.

Exemplarily, a hierarchical spatial-and-temporal neural network can be used to capture the long-term dependence among long-distance regions. As shown in FIG. 2, a certain target range is divided into three levels, including administrative regions, functional zones, and cities. FIG. 2 from bottom to top is first-level regions, second-level regions, third-level regions, symbol 21 represents a vector operation symbol, and node 22 is a node corresponding to the region. It can be seen that within the same target range, roughly the higher the level, the smaller the number of regions.

Specifically, by constructing a three-level hierarchy: city→functional zone→region, the hierarchical neural network encodes long-distance spatial-and-temporal dependence information by spreading shared information from the top-level city to the fine-grained administrative area at bottom-level.

The spatial correlation information among the plurality of regions can also include the spatial-and-temporal correlation information among the plurality of regions or the spatial-and-temporal correlation information of at least one region in the plurality of regions during specific implementation. For example, the spatial correlation information among this region and other regions can be determined by the air quality observation values of each region at multiple historical moments.

Establishing the air quality prediction model according to the spatial correlation information among the plurality of regions specifically includes: establishing an air quality prediction model according to the spatial correlation information among the plurality of regions, so that the air quality prediction model can implement the prediction of air quality according to the spatial correlation information among the plurality of regions in the input data.

It should be understood that the process of model training and model construction includes the process of adjusting the model.

Adjustment to the air quality prediction model according to the air quality observation values for the plurality of regions and the air quality prediction values for the plurality of regions output by the air quality prediction model can be performed in the stage after the model is built and the model is trained, or the air quality prediction model can be further adjusted and optimized through data generated in actual use after the model training is completed and deployed.

In the embodiments of the present disclosure, when constructing an air quality prediction model, it is constructed based on the spatial correlation information among the plurality of regions, so that the spatial correlation information among the plurality of regions can be predicted according to the spatial correlation information among the plurality of regions when the model predicts the air quality, thereby improving the air quality predicting accuracy of the air quality prediction model.

In an embodiment, the spatial correlation information among the plurality of regions includes:

spatial correlation information among a plurality of levels of regions.

Exemplarily, the plurality of levels of regions can include two levels of regions and three levels of regions. Regions of the same level can be divided in the same way, and different levels of regions can overlap and belong to each other. For example, the administrative region belongs to the city.

Exemplarily, the regions of the same level may or may not overlap. For example, administrative regions do not overlap each other, but functional zones may overlap each other.

In this embodiment, the region is divided into a plurality of levels, so that when predicting, the spatial correlation among the fine-grained regions can be considered, and the upper-level region of the fine-grained region and the fine-grained region can also be considered, so that the air quality prediction is more accurate.

In an embodiment, the air quality correlation information among the plurality of levels of regions includes:

spatial correlation information among same level of regions; and

spatial correlation information among different levels of regions.

In this embodiment, the spatial correlation information among the same level of regions can be determined by the distance among the regions. For example, the spatial correlation information among the plurality of administrative regions can be determined by the distance among the administrative regions.

The spatial correlation information among different levels of regions can be determined by the distance among the different levels of regions and/or the attribution information among the different levels of regions. For example, the correlation information among a plurality of administrative regions and among a plurality of cities can be determined by the distance or belonging relationship among the administrative regions and the cities.

In other embodiments, the air quality correlation information among the plurality of levels of regions includes at least one of the following: spatial correlation information among the same level of regions and spatial correlation information among different levels of regions.

In this embodiment, the spatial correlation information among the plurality of same levels of regions and the spatial correlation information among different levels of regions are used to determine the correlation information among the plurality of regions, and thus the model constructed based on the correlation information can process the correlation information among regions and among region levels according to the input data, so that the air quality prediction can organically combine the spatial correlation among regions and improve accuracy of the air quality prediction.

In an embodiment, the spatial correlation information among the first-level regions is determined according to the adjacency matrix of the first-level regions and the air quality feature matrix of the first-level regions.

In this embodiment, first-level regions may be the lowest-level regions, that is, the most fine-grained regions, and may include fine-grained administrative division regions such as administrative regions, townships, and towns.

In the case of considering the spatial correlation information among different levels of regions, the spatial correlation information among the lower-level regions can be calculated first, and then the spatial correlation information among the higher-level regions is calculated according to the spatial correlation information among the lower-level regions.

As an example, the division levels of regions from low to high include: the first level, the second level, and the third level. When determining the spatial correlation information among the regions, specifically, the spatial correlation information of the first-level regions can be calculated first, And then the spatial correlation information of the second-level regions is determined according to the spatial correlation information of the first-level regions, and finally determine the spatial correlation information of the third-level regions is determined according to the spatial correlation information of the second-level regions.

As another example, the division levels of regions from low to high include: the first level, the second level, and the third level. When determining the spatial correlation information among the regions, specifically, the spatial correlation information of the first-level regions can be calculated first, and then the spatial correlation information of the second-level regions is determined according to the spatial correlation information of the first-level regions, and finally the spatial correlation information of the third-level regions is determined according to the spatial correlation information of the second-level regions and the spatial correlation information of the first-level regions.

The adjacency matrix of the first-level regions can be determined by the distance among the first-level regions, specifically, it can be determined by the distance among the regions with adjacent relationships among the first-level regions.

For example, the first-level regions include A, B, C, and D, where A, B and B, C and C, D are adjacent regions respectively, and A, D are non-adjacent regions, then the adjacency matrix of the first-level regions can be determined based on the distance between A and B, the distance between B and C, and the distance between C and D.

The air quality feature matrix of the first-level regions may be determined according to the air quality historical values of the first-level regions. Specifically, it can be determined according to the air quality observation values of the set number of historical time points.

In this embodiment, the spatial correlation information among the first-level regions is determined according to the adjacency matrix of the first-level regions and the air quality feature matrix of the first-level regions, so that the spatial correlation information among the first-level regions not only contains the correlation of geographic space, but also the correlation of air quality, so that when the subsequent air quality prediction is performed, comprehensive predictions can be made based on multiple factors, and more accurate prediction data can be obtained.

In an embodiment, the air quality correlation information among second-level regions is determined according to the adjacency matrix of second-level regions, the air quality feature matrix of the first-level regions, and the allocation probability matrix of the second-level regions.

In this embodiment, the allocation probability matrix of the second-level regions can be used to represent a possibility of correlation among the first-level regions and the second-level regions, for example, correlation between each first-level region and each second-level region.

The second-level regions may be regions that are divided in a different way from the first-level regions. For example, the second-level regions can be functional zones.

In this embodiment, the air quality feature matrix among first-level regions at all levels, the spatial correlation information among second-level regions is determined by the correlation information among the second-level regions and the first-level regions and the correlation information among the second-level regions within their current level, so that comprehensive predictions of air quality can be implemented by combining multiple factors, and the accuracy of the prediction results can be improved.

In an embodiment, the adjacency matrix of the second-level regions is determined according to the adjacency matrix of the first-level regions and the allocation probability matrix of the second-level regions.

In this embodiment, when determining the adjacency matrix of the second-level regions, considering the spatial correlation factors among the first-level regions makes the air quality prediction result more accurate.

In an embodiment, the allocation probability matrix of the second-level regions is determined according to a soft allocation matrix of the second-level regions, and an indication matrix indicating whether the first-level regions and the second-level regions belong to same third-level regions.

In this embodiment, when constructing the air quality prediction model, the connection among the first-level regions, the second-level regions and the third-level regions is considered to make the prediction result more accurate.

In an embodiment, the soft allocation matrix of the second-level regions is determined according to an environmental context feature of the first-level regions and the adjacency matrix of the first-level regions.

In various embodiments of the present disclosure, a functional zone may be a region with certain environmental or functional characteristics, such as an industrial area, a green area, a residential area, a planting area, etc. A region may have the characteristics of multiple functional zones at the same time, so that a region can belong to multiple functional zones at the same time. A part of the first-level region may belong to one or several functional zones, and the other part belongs to another one or several other functional zones.

In this embodiment, the second-level regions and the first-level regions are organically combined by calculating the allocation matrix and the soft allocation matrix, so that the prediction result is more accurate.

In an embodiment, the air quality correlation information among the second-level regions is calculated by:

multiplying the air quality feature matrix of the first-level regions by a transpose matrix of the allocation probability matrix of the second-level regions to obtain a first node characterization matrix of the second-level regions;

performing a graph convolution operation on the first node characterization matrix of the second-level regions and the adjacency matrix of the second-level regions to obtain a second node characterization matrix of the second-level regions; and

performing first gating operation on a product of the second node characterization matrix of the second-level regions and the allocation probability matrix of the second-level regions to obtain the air quality correlation information among the second-level regions.

In this embodiment, by calculating various parameters, air quality correlation, spatial correlation, and environmental correlation factors among regions are added to the air quality prediction process, so that the prediction result is more accurate.

In an embodiment, the performing the first gating operation on the product of the second node characterization matrix of the second-level regions and the allocation probability matrix of the second-level regions, includes:

calculating an environmental context feature matrix of the first-level regions, a weather feature matrix of the first-level regions and a first gating parameter matrix by using an activation function to obtain the first gating operation matrix; and

multiplying the first gating operation matrix, the second node characterization matrix of the second level regions, and the allocation probability matrix of the second level regions.

In this embodiment, the data of the second-level regions is filtered through a gating operation, so that the filtered data can retain the more useful data for air quality prediction based on the spatial correlation information of the first-level regions, so as to pave the way for the greatest simplification of subsequent calculations.

In an embodiment, air quality correlation information among the third-level regions is determined according to an adjacency matrix of the third-level regions, an air quality feature value matrix of the first-level regions, an allocation probability matrix of the third-level regions, and the allocation probability matrix of the second-level regions.

In this embodiment, on the basis of the first-level regions and second-level regions, third-level regions are divided, and the granularity of the third-level regions may be greater than the granularity of the first-level regions and second-level regions. For example, third-level regions can include have the characteristics of a plurality of first-level regions, and also of a plurality of second-level regions at the same time.

In this embodiment, the third-level regions can still be divided according to the administrative division method as the standard. For example, the third-level regions can be cities, district cities, and so on.

In this embodiment, on the basis of the first-level regions and the second-level regions, the third-level regions are further divided according to another division standard, so that during the training of the air quality prediction model, the correlation among different regions with a granularity from small to large can be taken into account, so that the model prediction result is more accurate.

In an embodiment, the adjacency matrix of the third-level regions is determined according to the allocation probability matrix of the third-level regions and the air quality feature matrix of the first-level regions.

The allocation probability matrix of the third-level regions can be specifically determined according to the correlation among the first-level regions and the third-level regions.

In this embodiment, when calculating the adjacency matrix of the third-level regions, the spatial information of the third-level regions and the first-level regions are combined, so that the air quality prediction model constructed can predict the air quality by summing the spatial relationship among the plurality of levels of regions, improving the accuracy of the air quality prediction.

In any embodiment of the present disclosure, whether it is the allocation probability matrix of the second-level regions or the allocation probability matrix of the third-level regions, it can be advanced in combination with the terrain and environmental factors of the actual geographic location. For example, in a plain area, the air quality among similar areas has a higher degree of mutual influence, and at the junction of a higher mountain area and a plain area, the degree of mutual influence of air quality is relatively small.

In this embodiment, when constructing the air quality prediction model, the spatial correlation among different levels of regions is taken into consideration, so that the model has a higher accurate prediction ability.

In an embodiment, the allocation probability matrix of the third-level regions is determined according to a soft allocation matrix of the third-level regions and an indication matrix indicating whether the second-level regions belong to the third-level regions.

In this embodiment, the air quality prediction model is constructed according to the spatial relationship among the second-level regions and the third-level regions, and the spatial relationship among the first-level regions and the third-level regions, so that the prediction result of the model is more accurate.

In an embodiment, the soft allocation matrix of the third-level regions is determined according to the adjacency matrix of the second-level regions and an environmental context feature matrix of the first-level regions.

In this embodiment, the air quality prediction model is constructed according to the spatial relationship among the second-level regions and the third-level regions, the environmental conditions of the first-level regions and the spatial relationship among the third-level regions, so that the prediction result of the model is more accurate.

In an embodiment, the air quality correlation information among the third-level regions is determined by:

multiplying a transpose matrix of the allocation probability matrix of the third-level regions by the air quality feature matrix of the first-level regions to obtain a first node characterization matrix of the third-level regions;

performing a graph convolution operation on the first node characterization matrix of the third-level regions and the adjacency matrix of the third-level regions to obtain a second node characterization matrix of the third-level regions; and

performing a second gating operation on the allocation probability matrix of the second-level regions, the allocation probability matrix of the third-level regions and the second node characterization matrix of the third-level regions to obtain the air quality correlation information among the third-level regions.

In this embodiment, when determining the spatial correlation information of the third-level regions, the spatial correlation information of the first-level and second-level regions is filtered, so that useful data can participate in the subsequent calculations, and the degree of complexity of the subsequent calculations is minimized.

In an embodiment, the performing the second gating operation on the allocation probability matrix of the second-level regions, the allocation probability matrix of the third-level regions and the second node characterization matrix of the third-level regions includes:

calculating an environmental context feature matrix of the first-level regions, a weather feature matrix of the first-level regions and a second gating parameter matrix by using an activation function to obtain the second gating operation matrix; and

multiplying the allocation probability matrix of the second-level regions, the allocation probability matrix of the third-level regions, and the second node characterization matrix of the third-level regions by the second gating operation matrix.

In this embodiment, when determining the spatial correlation information of the third-level regions, the spatial correlation information of the first-level and second-level regions is filtered, so that useful data can participate in the subsequent calculations, and the degree of complexity of the subsequent calculations is minimized.

In an embodiment, the establishing the air quality prediction model according to the spatial correlation information among the plurality of regions includes:

establishing the air quality prediction model according to spatial-and-temporal correlation information among the plurality of regions, the spatial-and-temporal correlation information being determined according to historical spatial-and-temporal correlation information and the spatial correlation information.

In this embodiment, the spatial-and-temporal correlation information includes spatial correlation information and spatial-and-temporal correlation information, and the spatial-and-temporal correlation information may be the degree of correlation between the air quality at a historical time and the air quality at the current time in the same area.

The historical spatial-and-temporal correlation information can be obtained by calculation from time to time according to an initial values of spatial-and-temporal correlation information. For example, the spatial-and-temporal correlation information at a second moment is calculated through the spatial-and-temporal correlation information (initial value) at a first moment; the spatial-and-temporal correlation information at a third moment is calculated through the spatial-and-temporal correlation information at the second moment . . . and so on.

The historical spatial-and-temporal correlation information may be spatial-and-temporal correlation information at multiple historical moments.

In this embodiment, when the model is constructed, the construction is based on the spatial-and-temporal correlation information of a plurality of regions, so that the accuracy of the prediction result of the model can be improved.

In an embodiment, the adjusting the air quality prediction model according to the air quality observation values for the plurality of regions and the air quality prediction values for the plurality of regions output by the air quality prediction model, includes:

calculating loss values according to least square error of the observation values and the prediction values; and

adjusting the air quality prediction model according to the loss values.

The observation values can be true air quality values detected by means of air quality detection.

In this embodiment, the least square error of the observation values and the prediction values are used to adjust and optimize the model, so that the prediction result of the model can be adjusted to be more accurate, and the prediction function of the model can be more perfect.

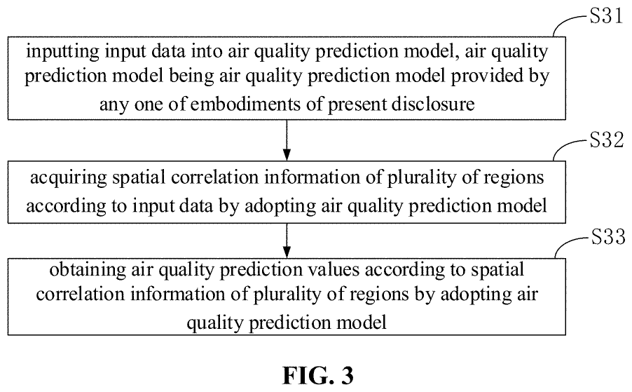

The embodiments of the present disclosure also provide an air quality prediction method. As shown in FIG. 3, the method includes:

S31. inputting input data into an air quality prediction model, the air quality prediction model being the air quality prediction model provided by any one of embodiments of the present disclosure;

S32. acquiring spatial correlation information of the plurality of regions according to input data by adopting the air quality prediction model; and

S33. obtaining the air quality prediction values according to the spatial correlation information of the plurality of regions by adopting the air quality prediction model.

The embodiments of the present disclosure adopt an air quality prediction model to perform air quality prediction. The air quality prediction model is a model obtained by the air quality prediction model training method provided by any one of the embodiments of the present disclosure, so that during predicting the spatial correlation information among the plurality of regions can be considered by the model to predict air quality, which has higher prediction accuracy.

In an embodiment, the obtaining the air quality prediction values according to the spatial correlation information of the plurality of regions by adopting the air quality prediction model, further includes:

obtaining spatial-and-temporal correlation information of the plurality of regions according to the spatial correlation information of the plurality of regions by adopting the air quality prediction model; and

obtaining the air quality prediction values according to the spatial-and-temporal correlation information of the plurality of regions by adopting the air quality prediction model.

In this embodiment, the input data includes spatial correlation information among the plurality of regions and spatial-and-temporal correlation information of air quality in each region of the plurality of regions. Therefore, the prediction result takes into account the spatial correlation among the regions and the temporal correlation at different moments, making the prediction result more accurate.

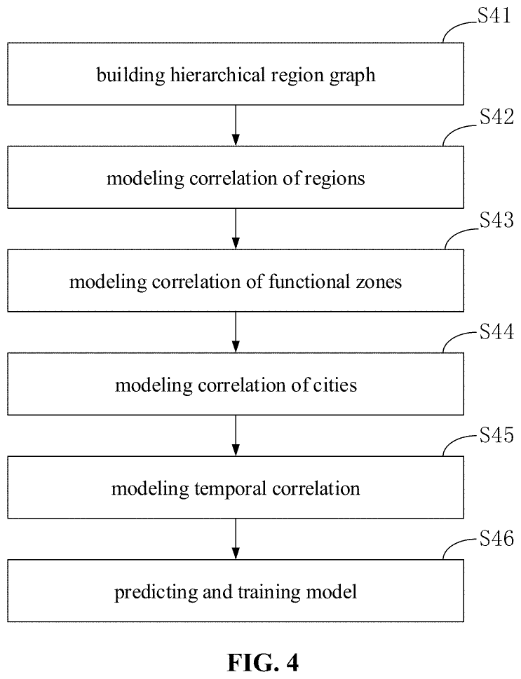

In an example of the present disclosure, the air quality prediction model training method includes the operations shown in FIG. 4.

S41. Building a hierarchical region graph. Refer to FIG. 2 for the region division of this example.

In this example, each city can be divided into a set of disjoint regions (denoted by R) according to standard township administrative divisions.

Each rᵢ ϵR represents a human gathering place with a specific name and geographic location (i.e., latitude and longitude).

Functional zone zᵢ ϵZ is composed of plurality of regions and has a kind of urban function, such as an ecological zone and an industrial zone.

A city cᵢ ϵC is a set of functional zones that integrates various functions such as administration, economy, culture, and transportation.

Regions, functional zones, and cities naturally form a bottom-up three-level hierarchy. The properties of different layers can be used to capture long-distance spatial dependence. A hierarchical region graph can be defined through the three-level hierarchy.

The hierarchical region graph is defined as G^{h}={V, E}, where V=R∪Z∪C is the node including region, functional zone and city, E={A_{R}, A_{Z}, A_{C}, A^{RZ}, A^{ZC}} is the edge among each node. Specifically, A_{R}, A_{Z} and A_{C} respectively represent (1) two regional nodes, (2) two functional zone nodes, (3) adjacency matrix of connectivity among two city nodes, A^{RZ} and A^{ZC} are the mapping weight matrixes from region to functional zone and from functional zone to city respectively.

In this example, regions and cities are real administrative regions in the real world, and functional zones are virtual nodes that the model of the present disclosure needs to learn.

S42. Modeling the correlation of the regions.

Since regions and cities are divided by administrative regions, Gaussian kernel in Formula (3) can be used to directly calculate the corresponding adjacency matrix A_{R} and A_{C},

$${a}_{i j}^{h} = exp ( - \frac{d i s {t ( {v}_{i} , {v}_{j} )}^{2}}{{δ}^{2}} ) ; \qquad ( Formula 1 )$$

where dist(vᵢ, vⱼ) is used to calculate the geographic spatial distance of vᵢ and vⱼ, δ is the standard deviation of the distance, and aᵢⱼ^{h} represents the edge weight of the nodes in the adjacent regions. The graph convolutional network (GCN) is used as the basic component for modeling the spatial correlation of the hierarchical region graph G^{h}. GCN is a lightweight and efficient graph neural network model, which can greatly reduce the computational complexity of hierarchical spatial correlation modeling. It is assumed that the input feature of the graph is X, first the graph convolution operation (GConv) is defined as:

$${X}^{′} = GConv ( X , A ) = σ ( {D}^{- \frac{1}{2}} A {D}^{- \frac{1}{2}} XW ) ; \qquad ( Formula 2 )$$

where X′ is the node characterization updated by the graph convolution operation, A represents the adjacency matrix, D is the degree matrix of the node, σ is the nonlinear activation function, and W represents the learnable parameter matrix. First, the graph convolution technology is used to capture the short-distance dependency by aggregate the information of adjacent regions.

X^{r}=GConv(X^{u},A_{R}) (Formula 3);

where X^{u} is the air quality feature matrix of all regions, and X^{r} contains the short-distance dependence information of the nodes in each region.

S43. Modeling the correlation of functional zones.

In the real world, each region can serve multiple functions at the same time. For example, business districts usually have many entertainment facilities.

In this example, it is assumed that each region has the opportunity to belong to multiple functional zones with different probabilities, instead of clustering each region into a specific functional zone. Because geographic Point of Interest (POI) and road network information can reflect the environment and functional layout of a region. Therefore, in this example, the graph convolution operation is first used to learn a soft allocation matrix S^{RZ} based on various environmental context features:

S^{RZ}=GConv(X^{c},A_{R}) (Formula 4);

where S^{RZ} ϵR^{N}^{_{R}}^{×N}^{_{Z}}, each row of the matrix measures the possibility that a specific region is related to different functional zones. Since the functional zones of each city may be different, n_{z} independent functional zones are allocated to each city, where N_{Z}=|C|n_{z}.

In this example, an indicator matrix M^{RZ} is defined, where if the region r and the functional zone z belong to the same city, then M^{RZ} [r,z]=1, otherwise M^{RZ}[r, z]=0. The allocation matrix A^{RZ} from region to functional zone can be calculated as follows:

A^{RZ}=Softmax(M^{RZ}⊙S^{RZ}) (Formula 5);

where ⊙ represents the multiplication of matrix elements, and A^{RZ}[r, z] can be regarded as the probability that the region r is mapped to the functional zone z. Characterization of each functional zone xᵢ^{z}ϵX^{Z} can be obtained by the linear combination of the underlying region characterization:

X^{Z}=(A^{RZ})^{T}X^{u} (Formula 6).

where (A^{RZ})^{T} is the transposed matrix of the matrix A^{RZ}. Similarly, the adjacency matrix A_{Z} of the functional zone nodes is further obtained by Formula (7):

A_{Z}=(A^{RZ})^{T}A_{R}A^{RZ} (Formula 7).

Similar to the spatial dependency modeling of regional nodes, the graph convolution operation can be used to capture the dependencies among functional zones:

X^{z}′=GConv(X^{z},A_{Z}) (Formula 8).

In addition, it has been proven that weather conditions and POI density can significantly affect the transmission and diffusion of air pollutants in different areas. In order to further model the influence of external environmental factors on air quality, a gating message transfer mechanism can be designed to control the transfer of information from the functional zone to the bottom region, namely:

x^{rz}=G_{Z}⊙(A^{RZ}X^{z}′) (Formula 9);

where G_{Z} is the output of the gating mechanism, which can be defined as:

G_{Z}=Sigmoid((X^{m,t}∥X^{c})W_{z}) (Formula 10);

where X^{m,t} is the weather feature of all regions at time t, X^{c} represents the environmental context feature of all regions, and W_{z} is a learnable parameter matrix. By using the above-mentioned gating mechanism, the air quality prediction model of this example can adaptively capture the spatial interaction among long-distance areas under different environmental conditions.

S44. Modeling the correlation of the cities.

The spatial dependence of the city level is also modeled in a similar way. First, in this example, the same graph convolution operation defined in Formula (4) is used to calculate the soft allocation matrix S^{ZC}. In order to avoid mutual interference among the functional zones of different cities, in this example, a mapping matrix M^{ZC} from functional zones to cities is set. If the functional zone z belongs to city c, then M^{ZC} [r, z]=1, otherwise, M^{ZC}[r, z]=0.

Based on Formulas (5) to (8), the region-to-city allocation matrix A^{ZC} and the city node characterizations X^{p} and X^{p}′ can be further obtained. Then, Formula (9) can be extended, and the calculation method of information propagation from high-level city nodes to low-level regional nodes is as follows:

X^{zc}=G_{C}⊙(A^{RZ}A^{ZC}X^{p}′) (Formula 11);

G_{C}=Sigmoid((X^{m,t}∥X^{c})Wₚ) (Formula 12);

where the symbol ⊙ can be used to represent the cross product of a matrix. Based on the above regional-level characterization xᵢ^{r,t} ϵX^{r}, functional area-level characterization xᵢ^{rz,t}ϵX^{rz}, and city-level characterization xᵢ^{rc,t}ϵX^{rc}, the unified hierarchical region characterization can be obtained as follows:

xᵢ^{t}=xᵢ^{r,t}∥xᵢ^{rz,t}∥xᵢ^{rc,t}∥xᵢ^{m,t} (Formula 13);

where xᵢ^{m,t} represents the current weather condition feature, and xᵢ^{t} contains different levels of long-distance spatial dependence information.

S45. Modeling temporal correlation.

The air quality of each regional node is not only related to the neighboring nodes on the graph, but also affected by its state at the previous moment. The graph neural network can be expanded by the Gate Recurrent Unit (GRU), and the graph neural network can be integrated into the GRU model for time-dependent modeling. Consider the characterization (xᵢ^{t-T}, xᵢ^{t-T+1}, . . . xᵢ^{t}) for a region rᵢ and its past T moments, xᵢ^{t} is the output of the hierarchical graph convolution at the moment t. The states of rᵢ at t−1 moment and at t moment are denoted as hᵢ^{t-1} and hᵢ^{t}, respectively. The GRU operation is defined as follows:

hᵢ^{t}=GRU(hᵢ^{t-1},xᵢ^{t})=(1−zᵢ^{t})·hᵢ^{t-1}+zᵢ^{t}·\tilde{h}ᵢ^{t} (Formula 14);

zᵢ^{t} and \tilde{h}ᵢ^{t} are calculated as follows:

rᵢ^{t}=σ(Wᵣ[hᵢ^{t-1},xᵢ^{t}]+bᵣ) (Formula 15);

zᵢ^{t}=σ(W_{Z}[hᵢ^{t-1},xᵢ^{t}]+b_{z}) (Formula 16);

\tilde{h}ᵢ^{t}=tan h(W_{\tilde{h}}[rᵢ^{t}·hᵢ^{t-1},xᵢ^{t}]+b_{\tilde{h}}) (Formula 17);

By inputting the output hᵢ^{t-1} of the gate loop neural network at the moment t−1 and the output hᵢ^{t} of the hierarchical graph neural network at the moment t, the output hᵢ^{t} at moment t can be obtained by combining the gating mechanism. Since xᵢ^{t} contains the spatial correlation information at the moment t, and hᵢ^{t-1} contains the spatial-and-temporal correlation information before the moment t, the obtained hᵢ^{t} will contain both temporal correlation information and spatial correlation information. Among them, W_{\tilde{h}}, W_{z}, Wᵣ, bᵣ, b_{z}, b_{\tilde{h}} can be model parameters, which can be changed through model optimization or training. · can represent the cross product of the matrix.

S46. Predicting and training a model.

The hidden state hᵢ^{t} simultaneously encodes the past time-and-space dependence information, which can be directly used for regional air quality prediction. Using a feedforward neural network f(⋅) can generate future air quality predictions.

(ŷᵢ^{t+1},ŷᵢ^{t+2}, . . . ,ŷᵢ^{t+τ})=f(hᵢ^{t},xᵢ^{w},xᵢ^{c}) (Formula 18);

where, xᵢ^{w} and xᵢ^{c} are weather forecast and regional environmental context features. Similar to the existing air quality prediction work, in this example, the goal of model training can be to minimize the least square error between the real observation values and the prediction values. ŷᵢ^{t+1} and ŷᵢ^{t+2} can be the air quality prediction values at the moment t+1 . . . and so on.

$$L = \frac{1}{τ \vert R \vert} {\sum }_{i = 1}^{\vert R \vert} {\sum }_{j = 1}^{τ} {( {\hat{y}}_{i}^{t + j} - {y}_{i}^{t + j} )}^{2} . \qquad ( Formula 19 )$$

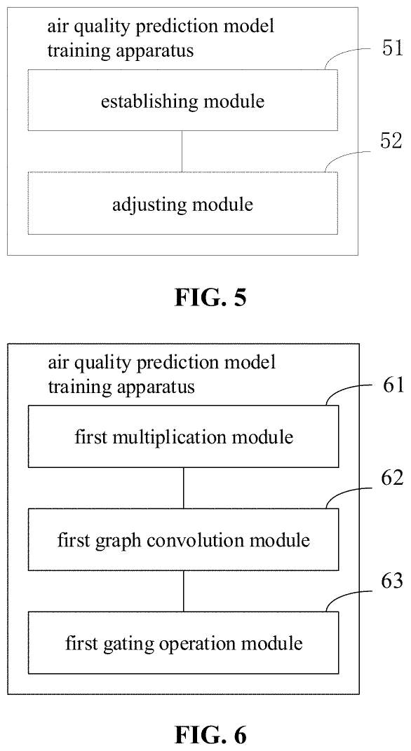

Embodiments of the present disclosure further provide an air quality prediction model training apparatus. As shown in FIG. 5, the apparatus includes:

an establishing module 51, configured for establishing an air quality prediction model according to spatial correlation information among a plurality of regions; and

an adjusting module 52, configured for adjusting the air quality prediction model according to air quality observation values for the plurality of regions and air quality prediction values for the plurality of regions output by the air quality prediction model.

In an embodiment, the spatial correlation information among the plurality of regions includes:

spatial correlation information among a plurality of levels of regions.

In an embodiment, the air quality correlation information among the plurality of levels of regions includes:

spatial correlation information among same level of regions; and

spatial correlation information among different levels of regions.

In an embodiment, the plurality of levels of regions include first-level regions, and spatial correlation information among the first-level regions is determined according to an adjacency matrix of the first-level regions and an air quality feature matrix of the first-level regions.

In an embodiment, air quality correlation information among the second-level regions is determined according to an adjacency matrix of the second-level regions, an air quality feature matrix of the first-level regions, and an allocation probability matrix of the second-level regions.

In an embodiment, the adjacency matrix of the second-level regions is determined according to the adjacency matrix of the first-level regions and the allocation probability matrix of the second-level regions.

In an embodiment, the allocation probability matrix of the second-level regions is determined according to a soft allocation matrix of the second-level regions, and an indication matrix indicating whether the first-level regions and the second-level regions belong to same third-level regions.

In an embodiment, the soft allocation matrix of the second level regions is determined according to an environmental context feature of the first-level regions and the adjacency matrix of the first-level regions.

In an embodiment, as shown in FIG. 6, the air quality correlation information among the second-level regions is determined by following modules of the apparatus:

a first multiplication module 61, configured for multiplying the air quality feature matrix of the first-level regions by a transpose matrix of the allocation probability matrix of the second-level regions to obtain a first node characterization matrix of the second-level regions;

a first graph convolution module 62, configured for performing a graph convolution operation on the first node characterization matrix of the second-level regions and the adjacency matrix of the second-level regions to obtain a second node characterization matrix of the second-level regions; and

a first gating module 63, configured for performing first gating operation on a product of the second node characterization matrix of the second-level regions and the allocation probability matrix of the second-level regions to obtain the air quality correlation information among the second-level regions.

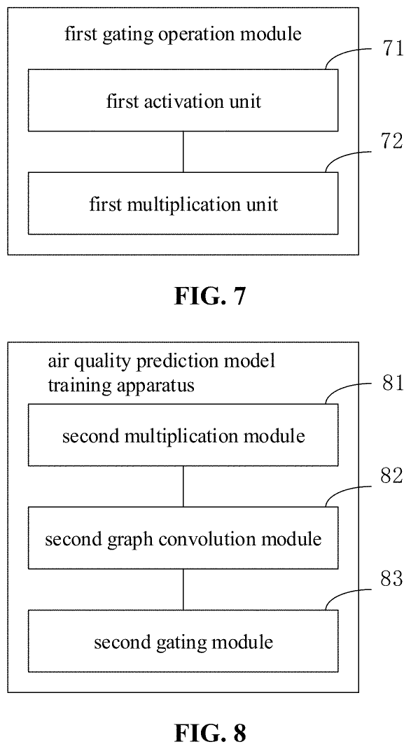

In an embodiment, as shown in FIG. 7, the first gating module includes:

a first activation unit 71, configured for calculating an environmental context feature matrix of the first-level regions, a weather feature matrix of the first-level regions and a first gating parameter matrix by using an activation function to obtain the first gating operation matrix; and

a first multiplication unit 72, configured for multiplying the first gating operation matrix, the second node characterization matrix of the second level regions, and the allocation probability matrix of the second level regions.

In an embodiment, air quality correlation information among the third-level regions is determined according to an adjacency matrix of the third-level regions, an air quality feature value matrix of the first-level regions, an allocation probability matrix of the third-level regions, and the allocation probability matrix of the second-level regions.

In an embodiment, the adjacency matrix of the third-level regions is determined according to the allocation probability matrix of the third-level regions and the air quality feature matrix of the first-level regions.

In an embodiment, the allocation probability matrix of the third-level regions is determined according to a soft allocation matrix of the third-level regions and an indication matrix indicating whether the second-level regions belong to the third-level regions.

In an embodiment, the soft allocation matrix of the third-level regions is determined according to the adjacency matrix of the second-level regions and an environmental context feature matrix of the first-level regions.

In an embodiment, as shown in FIG. 8, the air quality correlation information among the third-level regions is determined by following modules of the apparatus:

a second multiplication module 81, configured for multiplying a transpose matrix of the allocation probability matrix of the third-level regions by the air quality feature matrix of the first-level regions to obtain a first node characterization matrix of the third-level regions;

a second graph convolution module 82, configured for performing a graph convolution operation on the first node characterization matrix of the third-level regions and the adjacency matrix of the third-level regions to obtain a second node characterization matrix of the third-level regions; and

a second gating module 83, configured for performing a second gating operation on the allocation probability matrix of the second-level regions, the allocation probability matrix of the third-level regions and the second node characterization matrix of the third-level regions to obtain the air quality correlation information among the third-level regions.

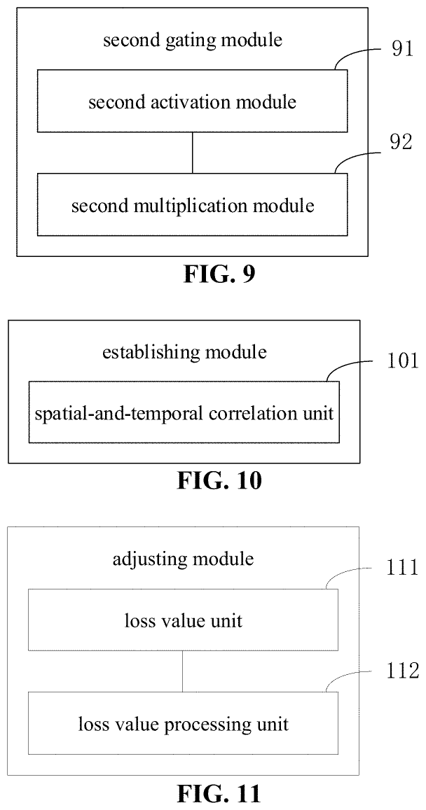

In an embodiment, as shown in FIG. 9, the second gating module includes:

a second activation module 91, configured for calculating an environmental context feature matrix of the first-level regions, a weather feature matrix of the first-level regions and a second gating parameter matrix by using an activation function to obtain the second gating operation matrix; and

a second multiplication module 92, configured for multiplying the allocation probability matrix of the second-level regions, the allocation probability matrix of the third-level regions, and the second node characterization matrix of the third-level regions by the second gating operation matrix.

In an embodiment, as shown in FIG. 10, the establishing module includes:

a spatial-and-temporal correlation unit 101, configured for establishing the air quality prediction model according to spatial-and-temporal correlation information among the plurality of regions, the spatial-and-temporal correlation information is determined according to historical spatial-and-temporal correlation information and the spatial correlation information.

In an embodiment, as shown in FIG. 11, the adjusting module includes:

a loss value unit 111, configured for calculating loss values according to least square error of the observation values and the prediction values; and

a loss value processing unit 112, configured for adjusting the air quality prediction model according to the loss values.

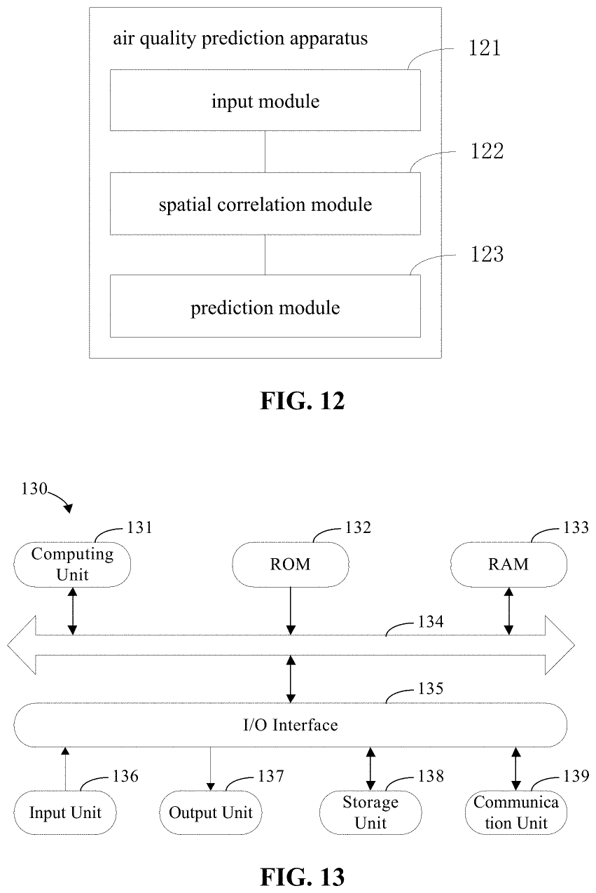

Embodiments of the present disclosure provide an air quality prediction apparatus. As shown in FIG. 12, the apparatus includes:

an input module 121, configured for inputting input data into an air quality prediction model, the air quality prediction model being the air quality prediction model of any one of embodiments of the present disclosure;

a spatial correlation module 122, configured for acquiring spatial correlation information of the plurality of regions according to the input data by adopting the air quality prediction model; and

a prediction module 123, configured for obtaining the air quality prediction values according to the spatial correlation information of the plurality of regions by adopting the air quality prediction model.

In an embodiment, the prediction module is further configured for:

obtaining spatial-and-temporal correlation information of the plurality of regions according to the spatial correlation information of the plurality of regions by adopting the air quality prediction model; and

obtaining the air quality prediction values according to the spatial-and-temporal correlation information of the plurality of regions by adopting the air quality prediction model.

The functions of the units, modules or sub-modules in the data processing apparatuses in the embodiments of the present disclosure can be referred to the corresponding descriptions in the above data processing methods, which will not be repeated here.

According to the embodiments of the present disclosure, the present disclosure also provides an electronic device, a readable storage medium and a computer program product.

FIG. 13 is a schematic block diagram of an electronic device 130 that may be configured for implementing the method provided by embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital processing, cellular telephones, smart phones, wearable devices, and other similar computing devices. The components shown herein, their connections and relationships, and their functions are by way of example only and are not intended to limit the implementations of the present disclosure described and/or claimed herein.

As shown in FIG. 13, the device 130 includes a computing unit 131, which can perform various appropriate actions and processing based on a computer program stored in a Read-Only Memory (ROM) 132 or a computer program loaded from the storage unit 138 into a Random Access Memory (RAM) 133. In the RANI 133, various programs and data required for the operation of the device 130 can also be stored. The calculation unit 131, the ROM 132, and the RAM 133 are connected to each other through a bus 134. An input/output (I/O) interface 135 is also connected to the bus 134.

A plurality of components in the device 130 are connected to the I/O interface 135, including: an input unit 136, such as keyboard, mouse, etc.; an output unit 137, such as various types of displays, speakers, etc.; and a storage unit 138, such as disk, optical disc, etc.; and a communication unit 139, such as network card, modem, wireless communication transceiver, etc. The communication unit 139 allows the device 130 to exchange information/data with other devices through a computer network such as Internet and/or various telecommunication networks.

The computing unit 131 may be various general-purpose and/or special-purpose processing components with processing and computing capabilities. Some examples of the computing unit 131 include but are not limited to Central Processing Unit (CPU), Graphics Processing Unit (GPU), various dedicated Artificial Intelligence (AI) computing chips, various computing units running machine learning model algorithms, Digital Signal Processing (DSP), and any appropriate processor, controller, microcontroller, etc. The calculation unit 13 executes the various methods and processes described above, such as the air quality prediction model training method. For example, in some embodiments, the air quality prediction model training method may be implemented as a computer software program, which is tangibly contained in a machine-readable medium, such as the storage unit 138. In some embodiments, part or all of the computer programs may be loaded and/or installed on the device 130 via the ROM 132 and/or the communication unit 139. When the computer program is loaded into the RAM 133 and executed by the calculation unit 131, one or more operations of the air quality prediction model training method described above can be executed. Alternatively, in other embodiments, the calculation unit 131 may be configured to perform an air quality prediction model training method through any other suitable means (for example, by means of firmware).

Various implementations of the systems and technologies described herein above can be implemented in digital electronic circuit systems, integrated circuit systems, Field Programmable Gate Arrays (FPGA), Application Specific Integrated Circuits (ASIC), Application-Specific Standard Products (ASSP), System On Chip (SOC), Complex Programmable Logic Device (CPLD), computer hardware, firmware, software, and/or combination(s) thereof. These implementations may include: being implemented in one or more computer programs which can be executed and/or interpreted on a programmable system including at least one programmable processor, the programmable processor can be a special-purpose or general-purpose programmable processor that can receive data and instructions from the storage system, at least one input device, and at least one output device, and transmit the data and instructions to the storage system, the at least one input device, and the at least one output device.

The program code used to implement the method provided by the present disclosure can be written in any combination(s) of one or more programming languages. These program codes can be provided to the processors or controllers of general-purpose computers, special-purpose computers, or other programmable data processing devices, so that the program codes, when executed by the processors or controllers, enable the functions/operations specified in the flowcharts and/or block diagrams to be implemented. The program code can be executed entirely on the machine, or partly executed on the machine, or partly executed on the machine and partly executed on a remote machine as an independent software package, or entirely executed on the remote machine or server.

In the context of the present disclosure, a machine-readable medium may be a tangible medium, which may contain or store a program for use by an instruction execution system, apparatus, or device or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination(s) of the foregoing. More specific examples of machine-readable storage medium would include electrical connections according to one or more wires, portable computer disks, hard disks, Random Access Memory (RAM), Read-Only Memory (ROM), Erasable Programmable Read-Only Memory (EPROM or flash memory), optical fibers, portable Compact Disk Read-Only Memory (CD-ROM), optical storage device, magnetic storage device, or any suitable combination of the foregoing.

To provide for interaction with a user, the systems and techniques described herein may be implemented on a computer having: a display apparatus (e.g., a Cathode Ray Tube (CRT) or Liquid Crystal Display (LCD) monitor) for displaying information to a user; and a keyboard and a pointing apparatus (e.g., a mouse or a trackball) by which a user can provide input to the computer. Other types of apparatuses may also be used to provide interaction with a user; for example, the feedback provided to the user may be any form of sensory feedback (e.g., visual feedback, audile feedback, or tactile feedback); and input from the user may be received in any form, including acoustic input, audio input, or tactile input.

The systems and techniques described herein may be implemented in a computing system that includes a background component (e.g., as a data server), or a computing system that includes a middleware component (e.g., an application server), or a computing system that includes a front-end component (e.g., a user computer having a graphical user interface or a web browser through which a user may interact with embodiments of the systems and techniques described herein), or in a computing system that includes any combination of such background component, middleware component, or front-end component. The components of the system may be interconnected by digital data communication (e.g., a communication network) of any form or medium. Examples of the communication networks include: Local Area Networks (LANs), Wide Area Networks (WANs), and Internet.

The computer system may include a client and a server. The client and the server are typically remote from each other and typically interact through a communication network. A relationship between the client and the server is generated by computer programs operating on respective computers and having a client-server relationship with each other.

It will be appreciated that the various forms of flow, reordering, adding or removing operations shown above may be used. For example, the operations recited in the present disclosure may be performed in parallel or sequentially or may be performed in a different order, so long as the desired results of the technical solutions disclosed in the present disclosure can be achieved, and no limitation is made herein.

The above-mentioned embodiments are not to be construed as limiting the scope of the present disclosure. It will be apparent to a person skilled in the art that various modifications, combinations, sub-combinations and substitutions are possible, depending on design requirements and other factors. Any modifications, equivalents, and improvements within the spirit and principles of the present disclosure are intended to be included within the scope of the present disclosure.

What is claimed is:

1. An air quality prediction model training method, comprising:
establishing an air quality prediction model according to spatial correlation information among a plurality of regions; and
adjusting the air quality prediction model according to air quality observation values for the plurality of regions and air quality prediction values for the plurality of regions output by the air quality prediction model.

2. The method of claim 1, wherein the spatial correlation information among the plurality of regions comprises: spatial correlation information among a plurality of levels of regions, and
wherein air quality correlation information among the plurality of levels of regions comprises:
spatial correlation information among same level of regions; and/or
spatial correlation information among different levels of regions.

3. The method of claim 2, wherein the plurality of levels of regions comprise first-level regions, and spatial correlation information among the first-level regions is determined according to an adjacency matrix of the first-level regions and an air quality feature matrix of the first-level regions.

4. The method of claim 3, wherein the plurality of levels of regions comprise second-level regions, and air quality correlation information among the second-level regions is determined according to an adjacency matrix of the second-level regions, the air quality feature matrix of the first-level regions, and an allocation probability matrix of the second-level regions.

5. The method of claim 4, wherein the adjacency matrix of the second-level regions is determined according to the adjacency matrix of the first-level regions and the allocation probability matrix of the second-level regions, and/or
wherein the plurality of levels of regions comprises third-level regions, and the allocation probability matrix of the second-level regions is determined according to a soft allocation matrix of the second-level regions, and an indication matrix indicating whether the first-level regions and the second-level regions belong to same third-level regions.

6. The method of claim 5, wherein the soft allocation matrix of the second level regions is determined according to an environmental context feature of the first-level regions and the adjacency matrix of the first-level regions.

7. The method of claim 4, wherein the air quality correlation information among the second-level regions is calculated by:
multiplying the air quality feature matrix of the first-level regions by a transpose matrix of the allocation probability matrix of the second-level regions to obtain a first node characterization matrix of the second-level regions;
performing a graph convolution operation on the first node characterization matrix of the second-level regions and the adjacency matrix of the second-level regions to obtain a second node characterization matrix of the second-level regions; and
performing first gating operation on a product of the second node characterization matrix of the second-level regions and the allocation probability matrix of the second-level regions to obtain the air quality correlation information among the second-level regions.

8. The method of claim 7, wherein the performing the first gating operation on the product of the second node characterization matrix of the second-level regions and the allocation probability matrix of the second-level regions, comprises:
calculating an environmental context feature matrix of the first-level regions, a weather feature matrix of the first-level regions and a first gating parameter matrix by using an activation function to obtain the first gating operation matrix; and
multiplying the first gating operation matrix, the second node characterization matrix of the second level regions, and the allocation probability matrix of the second level regions.

9. The method of claim 4, wherein the plurality of levels of regions comprises third-level regions, and air quality correlation information among the third-level regions is determined according to an adjacency matrix of the third-level regions, an air quality feature value matrix of the first-level regions, an allocation probability matrix of the third-level regions, and the allocation probability matrix of the second-level regions.

10. The method of claim 9, wherein the adjacency matrix of the third-level regions is determined according to the allocation probability matrix of the third-level regions and the air quality feature matrix of the first-level regions, and/or
wherein the allocation probability matrix of the third-level regions is determined according to a soft allocation matrix of the third-level regions and an indication matrix indicating whether the second-level regions belong to the third-level regions.

11. The method of claim 9, wherein the soft allocation matrix of the third-level regions is determined according to the adjacency matrix of the second-level regions and an environmental context feature matrix of the first-level regions.

12. The method of claim 9, wherein the air quality correlation information among the third-level regions is determined by:
multiplying a transpose matrix of the allocation probability matrix of the third-level regions by the air quality feature matrix of the first-level regions to obtain a first node characterization matrix of the third-level regions;
performing a graph convolution operation on the first node characterization matrix of the third-level regions and the adjacency matrix of the third-level regions to obtain a second node characterization matrix of the third-level regions; and
performing a second gating operation on the allocation probability matrix of the second-level regions, the allocation probability matrix of the third-level regions and the second node characterization matrix of the third-level regions to obtain the air quality correlation information among the third-level regions.

13. The method of claim 12, wherein the performing the second gating operation on the allocation probability matrix of the second-level regions, the allocation probability matrix of the third-level regions and the second node characterization matrix of the third-level regions, comprises:
calculating an environmental context feature matrix of the first-level regions, a weather feature matrix of the first-level regions and a second gating parameter matrix by using an activation function to obtain the second gating operation matrix; and
multiplying the allocation probability matrix of the second-level regions, the allocation probability matrix of the third-level regions, and the second node characterization matrix of the third-level regions by the second gating operation matrix.

14. The method of claim 1, wherein the establishing the air quality prediction model according to the spatial correlation information among the plurality of regions, comprises:
establishing the air quality prediction model according to spatial-and-temporal correlation information among the plurality of regions, the spatial-and-temporal correlation information being determined according to historical spatial-and-temporal correlation information and the spatial correlation information; and/or
the adjusting the air quality prediction model according to the air quality observation values for the plurality of regions and the air quality prediction values for the plurality of regions output by the air quality prediction model, comprises:
calculating loss values according to least square error of the observation values and the prediction values; and
adjusting the air quality prediction model according to the loss values.

15. An air quality prediction method, comprising:
inputting input data into an air quality prediction model, the air quality prediction model being the air quality prediction model obtained by the air quality prediction model training method of claim 1;
acquiring spatial correlation information of the plurality of regions according to input data by adopting the air quality prediction model; and
obtaining the air quality prediction values according to the spatial correlation information of the plurality of regions by adopting the air quality prediction model.

16. The method of claim 15, wherein the obtaining the air quality prediction values according to the spatial correlation information of the plurality of regions by adopting the air quality prediction model, further comprises:
obtaining spatial-and-temporal correlation information of the plurality of regions according to the spatial correlation information of the plurality of regions by adopting the air quality prediction model; and
obtaining the air quality prediction values according to the spatial-and-temporal correlation information of the plurality of regions by adopting the air quality prediction model.

17. An electronic device, comprising:
at least one processor; and
a memory communicatively connected to the at least one processor; wherein
the memory is stored with instructions executable by the at least one processor to enable the at least one processor to perform operations of:
establishing an air quality prediction model according to spatial correlation information among a plurality of regions; and
adjusting the air quality prediction model according to air quality observation values for the plurality of regions and air quality prediction values for the plurality of regions output by the air quality prediction model.

18. An electronic device, comprising:
at least one processor; and
a memory communicatively connected to the at least one processor; wherein
the memory is stored with instructions executable by the at least one processor to enable the at least one processor to perform operations of:
inputting input data into an air quality prediction model, the air quality prediction model being the air quality prediction model obtained by the electronic device of claim 17;
acquiring spatial correlation information of the plurality of regions according to input data by adopting the air quality prediction model; and
obtaining the air quality prediction values according to the spatial correlation information of the plurality of regions by adopting the air quality prediction model.

19. A non-transitory computer-readable storage medium storing computer instructions for causing a computer to perform operations of:
establishing an air quality prediction model according to spatial correlation information among a plurality of regions; and
adjusting the air quality prediction model according to air quality observation values for the plurality of regions and air quality prediction values for the plurality of regions output by the air quality prediction model.

20. A non-transitory computer-readable storage medium storing computer instructions for causing a computer to perform operations of:
inputting input data into an air quality prediction model, the air quality prediction model being the air quality prediction model obtained by the non-transitory computer-readable storage medium of claim 19;
acquiring spatial correlation information of the plurality of regions according to input data by adopting the air quality prediction model; and
obtaining the air quality prediction values according to the spatial correlation information of the plurality of regions by adopting the air quality prediction model.
